(19) United States
(12) Patent Application Publication
(10) Pub. No.: US 2011/0149089 A1
(43) Pub. Date: Jun. 23, 2011

(54) SYSTEM AND METHOD FOR GENERATING AN IMAGE APPENDED WITH LANDSCAPE INFORMATION

(75) Inventor: De-Wei YANG, Taoyuan County (TW)

(73) Assignee: ALTEK CORPORATION, Hsinchu (TW)

(21) Appl. No.: 12/762,569

(22) Filed: Apr. 19, 2010

(30) Foreign Application Priority Data
Dec. 23, 2009 (TW) 98144463

(51) Int. Cl. H04N 5/225; H04N 5/76; G06K 9/00; G01C 19/38; G01S 19/42

(52) U.S. Cl. 348/207.1; 348/231.6; 382/106; 33/324; 342/357.25; 348/E05.024

(57) ABSTRACT

A system and method for generating an image appended with extra landscape information are disclosed. An image recorder is provided, and having a global-positioning system, an electronic compass, a gyro sensor, and an accelerometer for determining the space information as capturing an image. Under the determination, the space information can include a view angle, a direction, an elevation angle, and a coordinate. The information is used to compare with the content of a database, in order to obtain the landscape information of the image. After that, an image appended with the landscape information is generated. Thereby, the image appended with the landscape information may be used for generating a space map and be a liveview of the recorder.

### BACKGROUND OF THE INVENTION

1. Field of the Invention

The present invention generally relates to a system and method for generating an image appended with landscape information, more particularly to an image recorder recording a viewing angle, distance, direction, elevation angle and coordinates as taking the image, so as to create the image appended with landscape information.

2. Description of Related Art

When a camcorder or digital camera is used to take a picture, an exchangeable image file (EXIF) will be recorded with the picture conventionally. The EXIF records the attribute of the picture, and includes the data, time and any related information as photographing. According to the present technology, a global positioning system (GPS) is further introduced to enter the coordinates as photographing. The GPS data can be used for later filing or any other purpose.

The following table exemplarily lists some items recorded in EXIF:

| Items | Information |
|---|---|
| manufacturer | Sony |
| camera model | Sony T2 |
| image resolution X | 72 |
| image resolution Y | 72 |
| resolution unit resolution unit | dpi |
| last change date | 2008:10:06 10:23:52 |
| exposure time | 0.00800 ( 1/125) sec |
| aperture | F2.4 |
| photograph mode | Aperture priority |
| ISO value | 64 |
| EXIF version | 30, 32, 32, 31 |
| photograph time | 2008:10:02 10:18:00 |
| storage time | 2008:10:02 10:18:00 |
| exposure compensation | 0 |
| metering mode | Spot metering |
| flash | off |
| Lens focal length | 55 mm |
| color space | sRGB |
| image scale X | 1600 pixel |
| image scale Y | 1200 pixel |

### SUMMARY OF THE INVENTION

The present invention provides a system and a method for generating an image appended with landscape information. In particular, the exchangeable image file (EXIF) is introduced to record the parameters generated as photographing by an image recorder. Those parameters are the information recorded as the timing of photographing, such as a viewing, direction, elevation angle and coordinates. The viewing angle and the distance to the object can be obtained by controlling the focus. The direction toward the object can be determined using an electronic compass disposed in the image recorder. Further, the elevation angle can be detected by an accelerometer in the image recorder. A global positioning system inside the image recorder is used to obtain the geographic coordinates as photographing. Then these parameters are compared with the landscape information recorded in a database, and to determine what is the object to be pictured in reference with the location, direction, viewing angle and distance. Even the elevation angle is under consideration to determine more precise landscape information of the object.

In a preferred embodiment, the system for generating the image appended with landscape information is applicable to an image recorder. The image recorder has a micro-processing unit, which is electrically connected to the circuits in the system, is used for processing the image signals with the landscape information. The system further has an image capturing unit for capturing the image through lens. At the moment of photographing, the final focus adjusted by the image capturing unit can be used to determine the viewing angle and the distance to the object. The system has an image information controlling unit for generating space information associated with the image. The space information at least includes distance, direction, elevation angle and coordinates, etc.

A memory unit in the system is used to buffer the image signals processed by the micro-processing unit. The memory unit is connected with the database having records of landscape information, thereby the object can be determined by comparing the space information and the landscape information. After that, an image generating unit in the system combines the determined landscape information and the taken image. The image appended with the landscape information is generated.

The mentioned direction to the object can be detected by an electronic compass as photographing. The electronic compass preferably operates with a gyro sensor in order to enhance the detection accuracy. Furthermore, the elevation angle is detected by an accelerometer, and the coordinate value is generated by a global positioning system disposed in the system.

According to the preferred embodiment of the system of the present invention, a method for generating the image appended with landscape information is provided. A digital camcorder is preferred incorporated to capture the image through its lens at a first step. While any image is taken, the every current space information related to the image is recorded. The space information preferably includes a focal length, a direction, an elevation angle, and a set of coordinate value. The space information is then compared with the landscape information in a database. The landscape information includes a location, height, size related to a specific landscape. After that, the corresponding landscape information in connection with the object to be taken is obtained. Consequently, the landscape information is appended with the image.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 depicts a schematic diagram having a place and an object shown on an electronic map;

FIG. 2A is a schematic diagram illustrating space relationship between the location and the object to be taken;

FIG. 2B is a schematic diagram depicting a viewing angle between an image recorder and the object to be taken;

FIG. 2C is a schematic diagram depicting an elevation angle between the image recorder and the object to be taken;

FIG. 3 shows a diagram of the image appended with the landscape information in accordance with the present invention;

FIG. 4 shows a circuit block of the system for generating the image appended with the landscape information in accordance with the present invention;

FIG. 5 is a flow chart illustrating the method for generating the image appended with the landscape information according to an embodiment of the present invention;

FIG. 6 is a flow chart of the method of another embodiment in accordance with the present invention;

FIG. 7 is a flow chart of showing the image with the landscape information in the present invention.

### DETAILED DESCRIPTION OF THE PREFERRED EMBODIMENTS

While the present invention will be described more fully hereinafter with reference to the accompanying drawings, in which a preferred embodiment(s) of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The present invention particularly incorporates a feature that the digital picture is recorded with the information as photographing. Such as the exchangeable image file (EXIF), that is often used to record the information as photographing. In accordance with the present invention, an image recorder is equipped with one or more detectors capable of detecting the conditions while the picture is taken by a user who manipulates the image recorder. For example, the photo-taking location can be detected by a global positioning system built in the image recorder, and a set of coordinate value is also recorded. The direction toward the object to be taken can be detected by an electronic compass built in the image recorder. This electronic compass can perform with a gyro sensor which is designed under a theory of angular momentum conservation and used to sense or maintain the direction. Therefore, the detected direction to the object can be more accurate.

The space information further includes an elevation angle, which is detected by an accelerometer built in the image recorder. In general, the accelerometer measures an induced acceleration and a reacting force of gravity caused by the image recorder in order to estimate the elevation angle. The space information also includes a viewing angle as photographing, in which a range of the object to be taken is determined by the image recorder according to a focus distanced from lens to an image sensor.

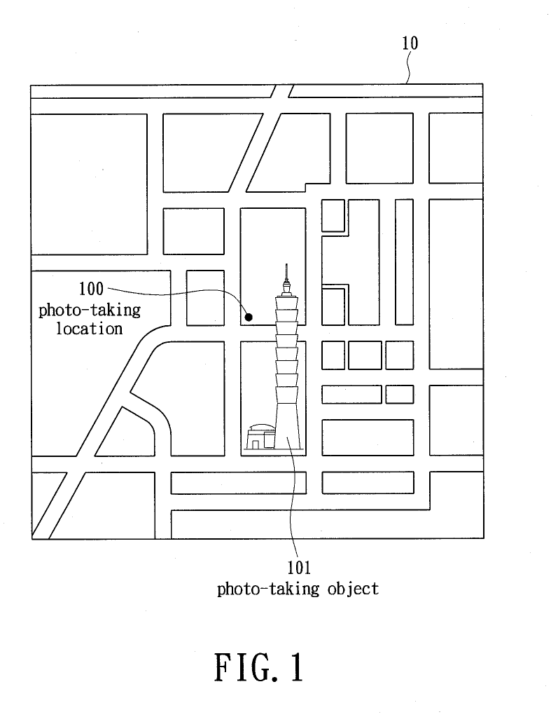

FIG. 1 shows an example of an electronic map including a photo-taking location and a photo-taking object. The mark 100 in the electronic map represents the photo-taking location, that is the location where the image is taken by the image recorder and detected by the global positioning system. The mark 101 indicates the photo-taking object which is exemplarily the Taipei 101 building.

One of the objects of the present invention is to provide a system used for generating the image appended with the landscape information. The landscape information is generated from the space information in comparison with the landscape information recorded in the database, in which the photo-taking location (global positioning coordinates), the direction to the Taipei 101 building, the elevation angle for covering the panoramic view of Taipei 101 building, the viewing angle and the distance from the object are taken in consideration.

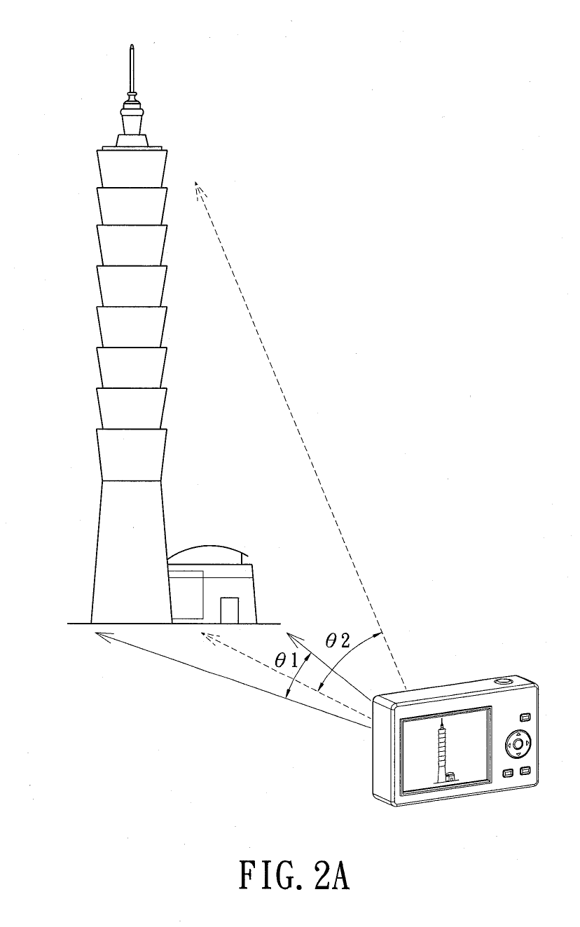

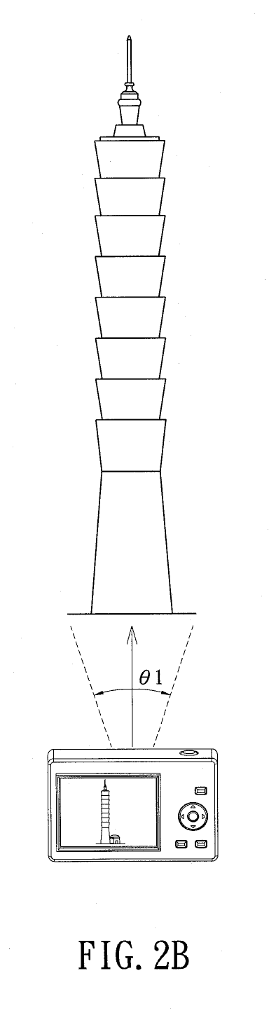

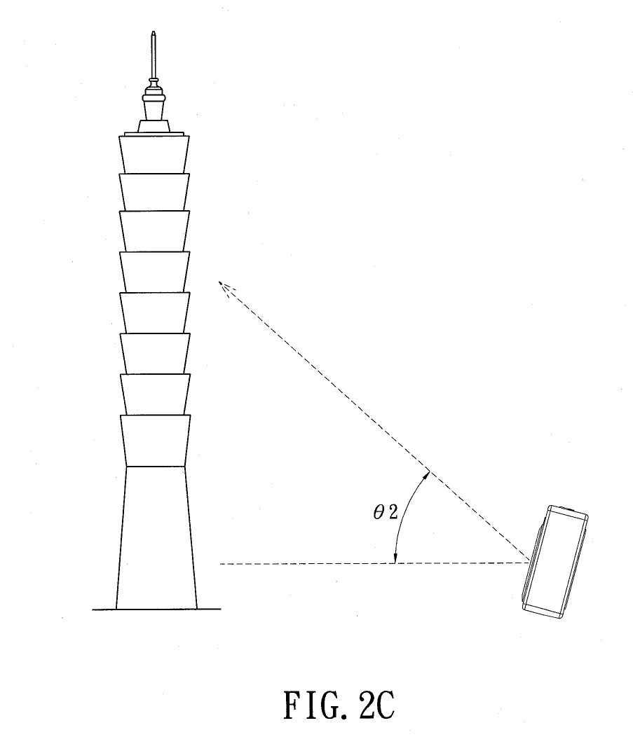

Reference is made to FIG. 2A showing the space relationship between the image recorder and the object to be taken. This diagram depicts the object to be taken by the image recorder. In order to photograph the object, some parameters need to be adjusted. For example, the focal length is configured to determine a proportion of the object in the image. The change of focal length can be used to determine a viewing angle θ1, which is the range for photographing. If a lens with shorter focal length is used, the viewing angle is bigger. Further, the lens with longer focal length makes the viewing angle smaller.

The elevation angle θ2 including upward and downward is detected by the accelerometer equipped in the system. This angle is obtained based on the relationship between the location as photographing and the photo-taking object when it is necessary to adopt a gesture with the elevation angle θ2.

FIG. 2B shows the relations of viewing angle between the image recorder and the object to be taken. The viewing angle θ1 can be detected through the changes of the focal length between the lens and the image sensor in the recorder.

Furthermore, FIG. 2C shows the relationship of elevation angle between the recorder and the object. The mentioned accelerometer in the image recorder is used to find the elevation angle θ2 as photographing.

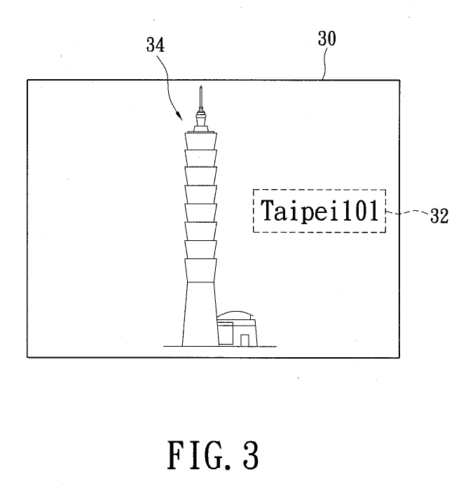

The above-described space information includes various parameters such as the photo-taking location, direction, elevation angle and viewing angle as photographing. After in comparison with the landscape information in the database, the object can be identified. Consequently, the text or any other type of information related to the identified object can be appended on the captured original image. Reference is made to the image with the landscape information shown in FIG. 3. In this exemplary example, the photo-taking object 34 is identified as Taipei 101 building, therefore the text [symbol] Taipei 101 [symbol] is appended with the information 32, and the appended image is displayed on the liveview screen 30.

More particularly, the provided system is capable of displaying the final image appended with the landscape information on the liveview screen in real time. For example, when the user uses the image recorder to capture an image, the mentioned photo-taking location, direction, elevation angle, distance toward the object, and viewing angle are detected immediately. After a comparison with the landscape information recorded in the database, the object can be identified instantly as landscape information. The landscape information is then displayed on the liveview screen 30 in any type of expression. Furthermore, since the space information can be recorded into the image's attribute, such as EXIF, the appended image can also be made at any time afterward.

According to an embodiment in accordance with the present invention, the image appended with the landscape information can be played on the image recorder. The EXIP is compared with the information in the database and the image is displayed on the liveview screen 30 while playing. Or alternatively, a playback program installed in a computer system is used to play the image appended with the landscape information. The playback program can install with the claimed system for generating the image having landscape information. So that, the playback program is able to retrieve the space information from the image, and determine the landscape information for the image. After that, the program also generates an image appended with the landscape information.

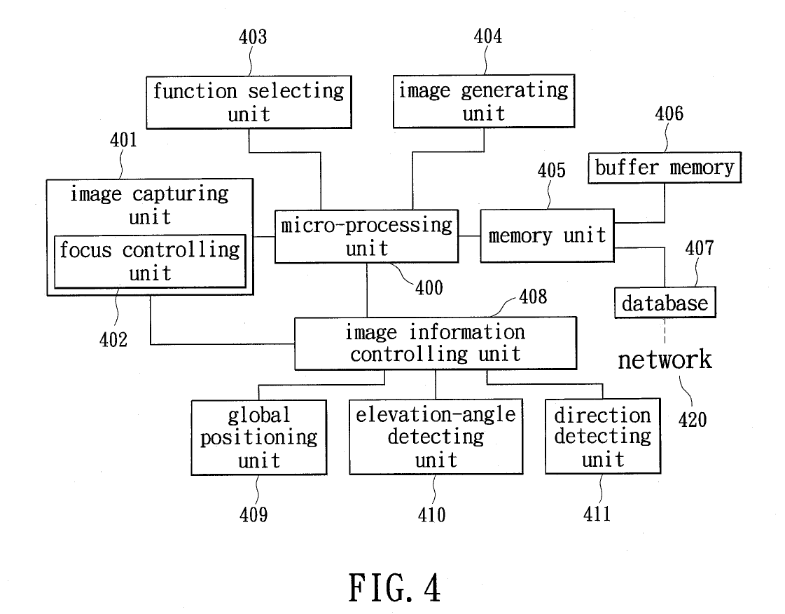

FIG. 4 shows the circuit blocks of the claimed system. It is featured to have a micro-processing unit 400 for processing the signals through whole system. The components electrically connected with the micro-processing unit 400 include an image capturing unit 401, a function selecting unit 403, an image generating unit 404, a memory unit 405, and an image information controlling unit 408. The image capturing unit 401 further includes a focus controlling unit 402.

The image information controlling unit 408 is electrically connected to the circuits for detecting the space information. Particularly, a global positioning unit 409, an elevation-angle detecting unit 410, and a direction detecting unit 411 are included. The memory unit 405 is the means for recording the information. In the diagram, a buffer memory 406 and database 407 are provided. The database 407 can be built in the system, or set at a remote server for providing the information via network.

In a preferred embodiment, the system for generating the image appended with the landscape information is particularly equipped with the image information controlling unit 408 electrically connected with the image micro-processing unit 400. The unit 408 retrieves the focal length generated by the focus controlling unit 402. The focal length can be referred to determine the viewing angle and distance as photographing. The unit 408 further retrieves the coordinate value detected by the global positioning unit 409, that is the coordinates of the photo-taking location. The unit 408 also retrieves the elevation angle detected by the elevation-angle detecting unit 410, such as the degree of elevation angle as the user holding the camera or digital camcorder. The unit 408 further retrieves the direction toward the object detected by the direction detecting unit 411.

When the claimed system is under operation, the inside image capturing unit 401 captures an image from the object through lens. The image capturing unit 401 is used to determine the viewing angle and the distance from the object by referring to the focus at the moment of photographing. The parameters, such as the focal length, coordinate value, elevation angle, and direction, are integrated by the image information controlling unit 408. The space information is transferred to the micro-processing unit 400, and buffered in the buffer memory 406 of the memory unit 405.

The memory unit 405 is able to buffer the image signals processed by the micro-processing unit 400. The memory unit 405 is connected with the database 407 having landscape information. The landscape information recorded in the database 407 are used to map the above-described space information for identifying the object to be taken. The image generating unit 404 connected with the micro-processing unit 400 then combines the landscape information and the captured image. Therefore, the image appended with the landscape information is generated.

The image appended with the landscape information can be displayed on an electronic liveview screen of the image recorder. The appended image can be applicable to a three-dimensional map used for an intuitive navigation system. Preferably, the image having an object with landscape information will be automatically displayed when the image recorder is directed toward the object. Through the electronic liveview screen, the image appended with the landscape information related to the object can be displayed instantly, such as the diagram shown in FIG. 3.

Another way to display the image appended with the information is to employ a playback program installed in a computer system. The program is associated with the database having the landscape information, and to retrieve the image's attribute. Then the result is played. Since the landscape information changes over time, the database 407 can be updated via network 420.

The direction toward the object to be taken can be detected by an electronic compass which operates as photographing. The electronic compass operates with a gyro sensor for reducing the possible perturbation and enhancing the detection accuracy. The elevation angle including upward and downward direction can be detected by the accelerometer. The coordinate value is obtained by the built-in global positioning system. The GPS signals can be used on the electronic map in order to determine what the scenes surrounding the object.

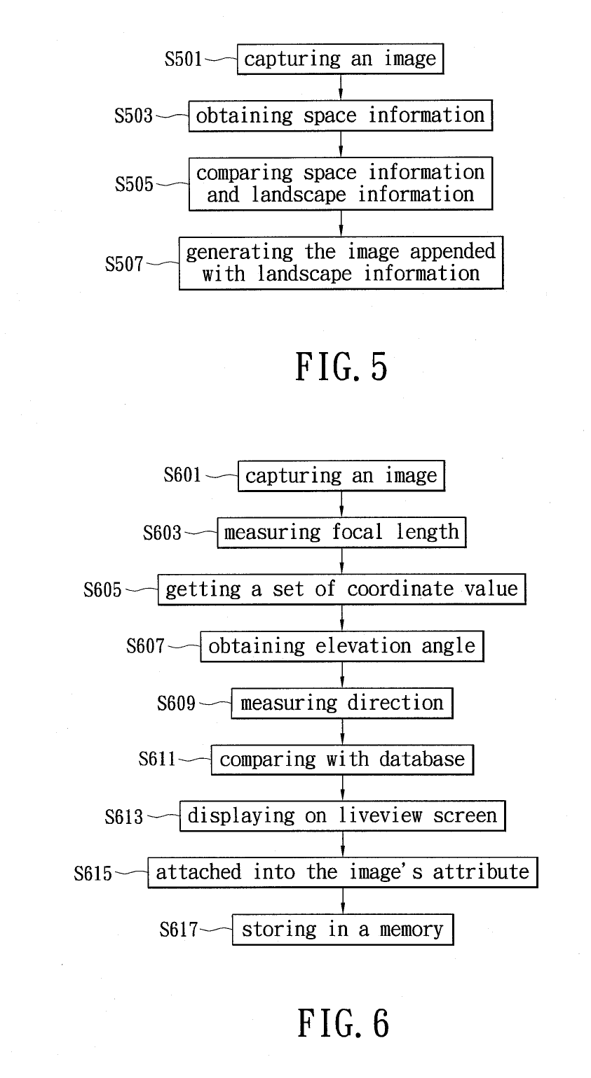

Reference is made to FIG. 5 illustrating a flow chart of the method for generating the image appended with landscape information. The method is applicable to the system described in FIG. 4.

The claimed system is essentially applied to generate the image in real time, such as the step S501. The image recorder is used to capture an image, and instantly the related space information is obtained through the plural detectors (step S503). The space information includes focal length, direction, elevation angle, a set of coordinate value, and one or in combination of the items is incorporated. In step S505, the space information in the database is compared with the data recorded in the database, and then the associated landscape information is obtained. At last, the image appended with the landscape information is displayed in real time in step S507.

FIG. 6 illustrates more detailed steps of the method in accordance with the present invention. In step S601, an image is first captured. Then the focus controlling unit measures a focal length in step S603, and the global positioning unit is to get a set of coordinate value in step S605. In the meantime, the elevation-angle detecting unit is used to obtain an elevation angle (step S607). Through the direction detecting unit, the direction to the object is measured (step S609). In practice, one or more items of the space information can be ignored, such as the elevation angle or/and focal length, and the landscape information can also be determined.

In next step S611, the space information is in comparison with the landscape information in the database (step S611). The landscape information appended on the image can be expressed by only text or any icon. The appended image is displayed on the liveview screen in step S613. In the meantime, the related space information is also attached into the image's attribute, such as EXIF (step S615). The image is consequently stored in a memory (step S617).

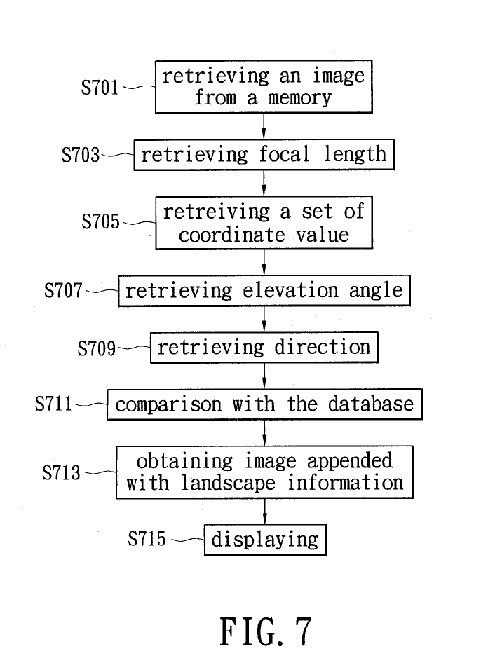

Besides the stored image should include the basic records in the attribute, some further space information is also recorded. The mentioned landscape information appended in the image and its space information can be used for future playback using any compatible player. FIG. 7 illustrates the flow chart of playing the images appended with the landscape information in accordance with the present invention.

In a first step S701, an image is retrieved from a memory, which is the storage medium used for storing the images generated from the image recorder. Next, the step S703 in the method is to retrieve the space information associated with the image as recorded during photographing, including a focal length, a set of coordinate value (step S705), an elevation angle (step S707), and a direction (step S709). In practice, the information retrieved from the attribute may only include some of the mentioned items as required.

After that, the retrieved space information is in comparison with the content of the database (step S711). Through the comparison, it is to determine what the photo-taking object, and the image is appended with the corresponding landscape information (step S713). And the appended image is played using a player (step S715).

In the summation of above description, the system and the method for generating the image appended with the landscape information are disclosed. The real-time detected space information is used to collocate with the landscape information in the database, and the photo-taking object can be determined instantly. Therefore, the image appended with the landscape information can be generated.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A system for generating an image appended with landscape information of an object, comprising:
a micro-processing unit used for processing signals of an image appended with the landscape information;
an image capturing unit used for capturing the image of the object;
an image information controlling unit, electrically with the micro-processing unit, retrieving space information after detection;
a memory unit, electrically connected with the micro-processing unit, having a buffer memory for buffering the signals processed by the micro-processing unit, and connected with a database, wherein the landscape information appended with the image is determined by referring to the space information;
an image generating unit, electrically connected with the micro-processing unit, used for generating the image appended with the landscape information.

2. The system of claim 1, wherein the space information includes a focal length which is generated by a focus controlling unit of the image capturing unit, thereby a viewing angle is determined.

3. The system of claim 2, further comprising a step of determining a distance toward the object.

4. The system of claim 1, wherein the space information includes a direction which is generated by a direction detecting unit electrically with the image information controlling unit.

5. The system of claim 4, wherein the direction detecting unit is an electronic compass.

6. The system of claim 5, wherein the electronic compass operates with a gyro sensor for enhancing detection accuracy.

7. The system of claim 1, wherein the space information includes an elevation angle, which is generated by an elevation-angle detecting unit electrically connected with the image information controlling unit.

8. The system of claim 7, wherein the elevation-angle detecting unit is an accelerometer.

9. The system of claim 1, wherein the space information includes a coordinate value, which is generated by a global positioning unit electrically connected with the image information controlling unit.

10. The system of claim 9, wherein the global positioning unit is implemented by a global positioning system retrieving positioning information from a satellite.

11. The system of claim 1, wherein the system further comprises a function selecting unit, and the system added with the landscape information appending function by a selection through the function selecting unit.

12. The system of claim 1, wherein the system is adapted to a digital camcorder.

13. The system of claim 12, wherein the image appended with the landscape information is generated in real time through the image generating unit, and the image is displayed on a liveview screen of the digital camcorder.

14. The system of claim 1, wherein the space information includes a focal length, a direction, an elevation angle, and a coordinate value.

15. The system of claim 14, wherein the focal length, the direction, the elevation angle, and the coordinate value are recorded in EXIF of the image.

16. A method for generating an image appended with landscape information, comprising:
retrieving an image;
obtaining space information as a timing for retrieving the image, wherein the space information includes:
a focal length for determining a viewing angle for the image and a distance toward the image;
a direction;
an elevation angle; and
a coordinate value;
comparing with a database for obtaining landscape information, which presents an object determined by referring to the focal length, the direction, the elevation angle, and the coordinate value; and
generating the image appended with the landscape information, and displaying the image on a liveview screen of a digital camcorder.

17. The method of claim 16, wherein the direction is generated by an electronic compass collocated with a gyro sensor.

18. The method of claim 16, wherein the elevation angle is generated by an accelerometer.

19. The method of claim 16, wherein the coordinate value is generated by a global positioning system.

20. The method of claim 16, wherein the landscape information in the database is updated via a network.
